(19) United States
(12) Patent Application Publication
(10) Pub. No.: US 2019/0150495 A1
(43) Pub. Date: May 23, 2019

(54) Sugar Product Containing L-arabinose and Preparing and Using Methods Thereof

(71) Applicant: Qingdao Mifutang Health Technology Co., Ltd., Qingdao (CN)

(72) Inventors: Lei WANG, Qingdao (CN); Chengfu WANG, Qingdao (CN); Xiaoning QIAO, Qingdao (CN)

(21) Appl. No.: 16/253,555

(22) Filed: Jan. 22, 2019

Related U.S. Application Data
(63) Continuation-in-part of application No. 14/261,442, filed on Apr. 25, 2014, now abandoned.

(30) Foreign Application Priority Data
Aug. 30, 2013 (CN) 201310384203.0

(51) Int. Cl. A23L 33/125; A23L 27/30; A23L 5/30

(52) U.S. Cl. CPC A23L 33/125; A23L 27/38; A23L 5/30; A23V 2002/00; A23V 2300/31; A23V 2250/602; A23V 2250/1578; A23V 2250/1582; A23V 2300/36; A23V 2200/132

(57) ABSTRACT

In the present invention, a sugar product containing L-arabinose and preparing and using methods thereof are provided. The sugar product comprises an edible sugar particle and an L-arabinose enclosing a surface of the edible sugar particle. The edible sugar particle has a particle diameter of 0.15 mm˜0.25 mm; the L-arabinose has an enclosing thickness of 0.001 mm˜0.08 mm; and in each mass part of the sugar product, the edible sugar particle accounts for 80%˜99% in mass percentage, and a dry matter of the L-arabinose accounts for 1%˜20% in mass percentage. With the solution as provided in the present invention, the uniformity of distribution of the L-arabinose on the surface of the edible sugar is improved.

### CROSS-REFERENCE TO RELATED APPLICATIONS

This application is a continuation-in-part application of patent application Ser. No. 14/261,442 filed on Apr. 25, 2014, which claims the benefit and priority of Chinese patent application No. 201310384203.0 filed on Aug. 30, 2013. Both of these applications are incorporated herein in their entirety by reference.

### TECHNICAL FIELD

The present invention relates to the technical field of food, and specifically to a sugar product containing L-arabinose and preparing and using methods thereof.

### BACKGROUND

The sucrose intake into the human body can not only cause rise of blood glucose of the human body, but also can turn into body fat and be stored in the body to cause obesity. During food processing, cooking or drink preparing, as it is inevitable to add sucrose to improve taste of the food or drink, the amount of sucrose of intake or absorption in normal life by the human being is relatively large. It is one of the reasons for cause obesity, fat diseases, diabetes and cardio-cerebral vascular diseases. Therefore, there is an urgent need for a healthy type sugar product which can be used in food processing, cooking or drink preparing.

### SUMMARY

In the embodiment of the present invention, a sugar product containing L-arabinose and preparing and using methods thereof are provided, improving the uniformity of distribution of the L-arabinose on the surface of the edible sugar.

A sugar product containing L-arabinose comprises an edible sugar particle and an L-arabinose enclosing a surface of the edible sugar particle, wherein the edible sugar particle has a particle diameter of 0.15 mm˜0.25 mm; the L-arabinose has an enclosing thickness of 0.001 mm˜0.08 mm; and in each mass part of the sugar product containing L-arabinose, the edible sugar particle accounts for 80%˜99% in mass percentage, and a dry matter of the L-arabinose accounts for 1%˜20% in mass percentage.

Preferably, the surface of the edible sugar particle further comprises calcium chloride; and in each mass part of the sugar product containing L-arabinose, a dry matter of the calcium chloride accounts for 0.5%˜1.5% in mass percentage.

Preferably, the surface of the edible sugar particle further comprises an edible glycerol; and in each mass part of the sugar product containing L-arabinose, the edible glycerol accounts for 0.5%˜1.5% in mass percentage.

Preferably, the edible sugar comprises: any one or more of raw sugar, white granulated sugar, soft white sugar, brown granulated sugar, golden granulated sugar, brown sugar powder, and crystal sugar powder.

A preparing method for the sugar product containing L-arabinose comprises: placing the edible sugar particles on a vibrating plate, wherein the edible sugar particles are placed with a thickness of 10 mm˜50 mm; preheating the edible sugar particles to 30˜50° C.; adjusting a vibration frequency of the vibrating plate to a target frequency, and the vibrating plate keeping vibrating at the target frequency; spraying an aqueous solution of the L-arabinose in mass percentage of 45%˜55% onto the edible sugar particles to obtain a solid-liquid mixture wherein the aqueous solution of the L-arabinose has a temperature of 30˜50° C.; after spraying, the vibrating plate continuing vibrating for 3˜5 minutes; using a vibration fluidized bed drying apparatus to dry the solid-liquid mixture wherein the vibration fluidized bed drying apparatus is used at a drying temperature of 30˜60° C. and for a drying period of 15˜30 minutes; using a vacuum drying manner to further dry the dried solid-liquid mixture wherein the vacuum drying manner is used with a vacuum degree of −0.1˜0 MPa and for a drying period of 40˜60 minutes.

Preferably, a relation between a mass of the edible sugar particles placed on the vibrating plate, the target frequency and a flow of spraying the aqueous solution of the L-arabinose meets the following first adjusting formula group:

$$\{ \begin{matrix}\frac{1}{5} \leq \frac{m}{M} \leq \frac{1}{3} , & R = 30 + ⌊ \frac{m}{100} ⌋ \times 10 , & f = ⌈ 20 + \frac{m}{M} \times 60 ⌉ \\ \frac{1}{3} \leq \frac{m}{M} \leq \frac{2}{3} , & R = 40 + ⌈ \frac{m}{100} ⌉ \times 10 , & f = ⌈ 15 + \frac{m}{M} \times 75 ⌉ \\ \frac{2}{3} \leq \frac{m}{M} \leq 1 , & R = 50 + ⌈ \frac{m}{100} ⌉ \times 10 , & f = ⌈ 25 + \frac{m}{M} \times 50 ⌉\end{matrix}$$

Here, m indicates the mass of the edible sugar particles placed on the vibrating plate, in a unit of kg; M indicates a maximum capability of the vibrating plate, in a unit of kg, and 300 kg≤M≤500 kg; R indicates the target frequency, in a unit of Hz; F indicates the flow of spraying the aqueous solution of the L-arabinose, in a unit of milliliter/minute.

Preferably, when the surface of the edible sugar particle further comprises calcium chloride and in each mass part of the sugar product containing L-arabinose, a dry matter of the calcium chloride accounts for 0.5%˜1.5% in mass percentage.

The step of spraying an aqueous solution of the L-arabinose in mass percentage of 45%˜55% onto the edible sugar particles comprises: spraying the aqueous solution of the L-arabinose/calcium chloride onto the edible sugar particles, wherein the aqueous solution of the L-arabinose/calcium chloride contains the dry matter of the L-arabinose in mass percentage of 45%˜55% and a dry matter of the calcium chloride in mass percentage of 10%˜20%.

In food processing or cooking or drink preparing, the sugar product containing L-arabinose is used to replace the originally needed sucrose in equal amount.

In the embodiments of the present invention, a sugar product containing L-arabinose and its preparing and using methods are provided. As the sugar product containing L-arabinose is presented in a form of the edible sugar particle and the L-arabinose enclosing the surface of the edible sugar particle, in each mass part of the sugar product, the edible sugar particle accounts for 80%˜99% in mass percentage, and a dry matter of the L-arabinose accounts for 1%˜20% in mass percentage, that is, the surface of the edible sugar particle is enclosed by the L-arabinose such that the L-arabinose can distribute more uniformly among the edible sugar particles, or even so uniform to a degree that each edible sugar may be adhered with the L-arabinose. The L-arabinose can suppress intake of sucrose in the edible sugar by the human body. Therefore, the sugar product containing L-arabinose as provided in the present invention not only ensures uniform distribution of the L-arabinose on the surface of the edible sugar, but also is a healthy type sweetener which can be used in the fields of food processing, cooking and drink preparing, etc. In addition, a certain amount of the sugar product containing L-arabinose has the sweetness consistent with that of equal amount of sucrose.

### DETAILED DESCRIPTION OF THE EMBODIMENTS

The embodiments of the present invention will be described in detail hereinafter, the examples of the embodiments are shown in the accompanying drawings, wherein the same or similar reference numerals throughout the drawings denote the same or similar elements or the elements having the same or similar functions. The embodiments described below with reference to the accompanying drawings are exemplary and are intended to explain the present invention, but cannot be construed as limiting the present invention.

In an embodiment of the present invention, a sugar product containing L-arabinose (called as sugar product for short) is provided, comprising an edible sugar particle and an L-arabinose enclosing a surface of the edible sugar particle, wherein the edible sugar particle has a particle diameter of 0.15 mm˜0.25 mm; the L-arabinose has an enclosing thickness of 0.001 mm˜0.08 mm; in each mass part of the sugar product, the edible sugar particle accounts for 80%˜99% in mass percentage, and a dry matter of the L-arabinose accounts for 1%˜20% in mass percentage.

For the edible sugar particles having a particle diameter larger than 0.25 mm, they can be crushed and ground to obtain the edible sugar particles having a particle diameter of 0.15 mm˜0.25 mm.

In addition, during production of the same batch of sugar products, the difference in particle diameter among the edible sugar particles is generally not larger than 0.04 mm.

The above sugar product may further comprise calcium chloride; the calcium chloride and the L-arabinose form a mixture enclosing the surface of the edible sugar particle; and a dry matter of the calcium chloride accounts for 0.5%˜1.5% in mass percentage.

In this case, the calcium chloride is on the surface of the edible sugar particle and is presented in the form of calcium chloride tetrahydrate. As can be found by naked eyes, the calcium chloride tetrahydrate exists in the surface of the edible sugar particle and can improve the gloss of the sugar product. In addition, the calcium chloride tetrahydrate can provide the human body with necessary calcium element such that the sugar product is also nutritious.

In the sugar product, if the dry matter of the calcium chloride has a mass percentage of above 1.5%, it will cause a block mass; and if the dry matter of the calcium chloride has a mass percentage of below 0.5%, the gloss of the sugar product can't be improved significantly.

The above sugar product may further comprise an edible glycerol; the edible glycerol and the L-arabinose are mixed, enclosing the surface of the edible sugar particle; and in each mass part of the sugar product, the edible glycerol accounts for 0.5%˜1.5% in mass percentage.

The presented edible glycerol can effectively improve the taste of the sugar product such that the food added with the sugar product tastes smoothly.

When the edible glycerol has a mass percentage of above 1.5%, the presented state of the sugar product will be affected or it may even cause adhesion between the edible sugar particles; and when the edible glycerol has a mass percentage of below 0.5%, the taste of the food added with the sugar product can't be improved significantly.

The particle diameter of 0.15˜0.25 mm can ensure that the L-arabinose is distributed uniformly on the surface of the edible sugar particle(s).

During preparation of the sugar product, it is necessary to control that the edible sugar particles are placed, with a thickness of 10˜50 mm, on a vibrating plate. In such thickness range, during vibration of the vibrating plate, over 99% of the edible sugar particles can be bounced to the air. Also, there is a distance in the range of 1˜5 mm between adjacent bounced edible sugar particles such that the edible sugar particles can be enclosed by the aqueous solution of the L-arabinose to ensure a uniform distribution.

The aqueous solution of the L-arabinose in mass percentage of 45%˜55% can be mixing-made by the L-arabinose concentrated solution, or can be mixing-made by the L-arabinose mother liquor, or can be mixing-made by the L-arabinose crystal, wherein the L-arabinose concentrated solution is a solution obtained by concentration of the original solution containing the L-arabinose, and the L-arabinose mother liquor is a solution obtained by crystallization and centrifugation of the L-arabinose original solution during preparation of the L-arabinose crystal.

By adjusting the vibration frequency of the vibrating plate and the flow of spraying the aqueous solution of the L-arabinose according to the following first adjusting formula group, the aqueous solution of the L-arabinose can be distributed uniformly on the edible sugar particle(s), and also the working efficiency of the vibrating plate is ensured to be maximized.

The first adjusting formula group:

$$\{ \begin{matrix}\frac{1}{5} \leq \frac{m}{M} \leq \frac{1}{3} , & R = 30 + ⌊ \frac{m}{100} ⌋ \times 10 , & f = ⌈ 20 + \frac{m}{M} \times 60 ⌉ \\ \frac{1}{3} \leq \frac{m}{M} \leq \frac{2}{3} , & R = 40 + ⌈ \frac{m}{100} ⌉ \times 10 , & f = ⌈ 15 + \frac{m}{M} \times 75 ⌉ \\ \frac{2}{3} \leq \frac{m}{M} \leq 1 , & R = 50 + ⌈ \frac{m}{100} ⌉ \times 10 , & f = ⌈ 25 + \frac{m}{M} \times 50 ⌉\end{matrix}$$

Here, m indicates the mass of the edible sugar particles placed on the vibrating plate, in a unit of kg; M indicates a maximum capability of the vibrating plate, in a unit of kg, and 300 kg≤M≤500 kg; R indicates the target frequency, in a unit of Hz; F indicates the flow of spraying the aqueous solution of the L-arabinose, in a unit of milliliter/minute (ml/min).

A relation between a mass of the edible sugar particles placed on the vibrating plate, the target frequency and a flow of spraying the aqueous solution of the L-arabinose/calcium chloride meets the following second adjusting formula group:

$$\{ \begin{matrix}\frac{1}{5} \leq \frac{m}{M} \leq \frac{1}{3} , & R = 30 + ⌊ \frac{m}{100} ⌋ \times 10 , & f = ⌈ 20 + \frac{m}{M} \times 60 ⌉ \\ \frac{1}{3} \leq \frac{m}{M} \leq \frac{2}{3} , & R = 40 + ⌈ \frac{m}{100} ⌉ \times 10 , & f = ⌈ 15 + \frac{m}{M} \times 75 ⌉ \\ \frac{2}{3} \leq \frac{m}{M} \leq 1 , & R = 50 + ⌈ \frac{m}{100} ⌉ \times 10 , & f = ⌈ 25 + \frac{m}{M} \times 50 ⌉\end{matrix}$$

Here, K indicates the target frequency, in a unit of Hz; P indicates the flow of spraying the aqueous solution of the L-arabinose/calcium chloride, in a unit of milliliter/minute.

The aqueous solution of the L-arabinose/calcium chloride indicates the mixed aqueous solution of the L-arabinose and the calcium chloride.

A relation between a mass of the edible sugar particles placed on the vibrating plate, the target frequency and a flow of spraying the aqueous solution of the L-arabinose/glycerol meets the following third adjusting formula group.

$$\{ \begin{matrix}\frac{1}{5} \leq \frac{m}{M} \leq \frac{1}{3} , & R = 30 + ⌊ \frac{m}{100} ⌋ \times 10 , & f = ⌈ 20 + \frac{m}{M} \times 60 ⌉ \\ \frac{1}{3} \leq \frac{m}{M} \leq \frac{2}{3} , & R = 40 + ⌈ \frac{m}{100} ⌉ \times 10 , & f = ⌈ 15 + \frac{m}{M} \times 75 ⌉ \\ \frac{2}{3} \leq \frac{m}{M} \leq 1 , & R = 50 + ⌈ \frac{m}{100} ⌉ \times 10 , & f = ⌈ 25 + \frac{m}{M} \times 50 ⌉\end{matrix}$$

Here, S indicates the target frequency, in a unit of Hz; T indicates the flow of spraying the aqueous solution of the L-arabinose/glycerol, in a unit of milliliter/minute.

The mass of the edible sugar particles on the vibrating plate is generally not lower than ⅕ of the maximum capability of the vibrating plate, ensuring the preparation efficiency.

### Embodiment 1

A vibrating plate having a maximum capability of 300 kg is selected; 200 kg of edible sugar particles is placed on the vibrating plate, with a thickness of 30 mm for placing the edible sugar particles; the edible sugar particles are preheated to 40° C., wherein the vibration frequency of the vibrating plate is 60 Hz.

4400 ml of the aqueous solution of the L-arabinose at a temperature of 50° C. is sprayed, in a spraying flow of 45 ml/min, onto the edible sugar particles, to obtain a solid-liquid mixture, wherein the aqueous solution of the L-arabinose contains the dry matter of the L-arabinose in mass percentage of 50%; after spraying, the vibrating plate continues vibrating for 3 min.

A vibration fluidized bed drying apparatus is used to dry the solid-liquid mixture at a drying temperature of 35° C. and for a drying period of 30 min.

A vacuum drying manner is used to further dry the previously dried solid-liquid mixture with a vacuum degree of −0.07 MPa and for a drying period of 60 min, wherein in the obtained product after drying, the L-arabinose has a mass content of 1% and the edible sugar has a mass content of 99%.

### Embodiment 2

According to the preparing method as provided in Embodiment 1, the mass of the edible sugar particles is adjusted to 200 kg; the thickness for placing the edible sugar particles is adjusted to 50 mm; the edible sugar particles are preheated to 50° C.; and the vibration frequency of the vibrating plate is adjusted to 80 Hz. The 4400 ml of the aqueous solution of the L-arabinose at a temperature of 50° C. is adjusted to 10000 ml of the aqueous solution of the L-arabinose/edible glycerol at a temperature of 40° C., the spraying flow is adjusted to 75 ml/min, wherein the aqueous solution of the L-arabinose/edible glycerol contains the dry matter of the L-arabinose in mass percentage of 45% and the edible glycerol of 20%. For the vibration fluidized bed drying apparatus, the drying temperature is adjusted to 50° C. and the drying period is adjusted to 20 min. Other parameters are unchanged. In the obtained product, the L-arabinose has a mass content of 1.5%, the edible sugar has a mass content of 97.8%, and the glycerol has a mass content of 0.7%.

### Embodiment 3

According to the preparing method as provided in Embodiment 1, some parameters are adjusted. The vibrating plate has the maximum capability of 400 kg; the mass of the edible sugar particles is 300 kg; the thickness for placing the edible sugar particles is 40 mm; the edible sugar particles are preheated to 50° C.; and the vibration frequency of the vibrating plate is 80 Hz. 1.37×105 ml of the aqueous solution of the L-arabinose at a temperature of 40° C. is used, the spraying flow is 53 ml/min, wherein the aqueous solution of the L-arabinose contains the dry matter of the L-arabinose in mass percentage of 55%. For the vibration fluidized bed drying apparatus, the drying temperature is 60° C. and the drying period is 15 min; the vacuum degree of vacuum drying is −0.1 MPa and the drying period is 40 min. Other parameters are unchanged. In the obtained product, the L-arabinose has a mass content of 20%, and the edible sugar has a mass content of 80%.

### Embodiment 4

According to the preparing method as provided in Embodiment 1, some parameters are adjusted. The vibrating plate has the maximum capability of 500 kg; the mass of the edible sugar particles is 100 kg; the thickness for placing the edible sugar particles is 10 mm; and the vibration frequency of the vibrating plate is 40 Hz. 10000 ml of the aqueous solution of the L-arabinose/calcium chloride at a temperature of 40° C. is used, the spraying flow is 32 ml/min, wherein the aqueous solution of the L-arabinose contains the dry matter of the L-arabinose in mass percentage of 55% and the dry matter of the calcium chloride of 16%. For the vibration fluidized bed drying apparatus, the drying temperature is 60° C. and the drying period is 15 min; the vacuum degree of vacuum drying is −0.1 MPa and the drying period is 40 min. In the obtained product, the L-arabinose has a mass content of 5%, and the edible sugar has a mass content of 93.5%, and the calcium chloride has a mass content of 1.5%.

During spraying, the temperature of the aqueous solution of the L-arabinose or the aqueous solution of the L-arabinose/calcium chloride or the aqueous solution of the L-arabinose/calcium chloride/edible glycerol is kept at 30˜50° C. which can ensure the flowability of the aqueous solution, thus the viscosity of the aqueous solution is in the best state.

### Embodiment 5

According to the preparing method as provided in Embodiment 1, some parameters are adjusted. The vibrating plate has the maximum capability of 500 kg; the mass of the edible sugar particles is 250 kg; the thickness for placing the edible sugar particles is 30 mm; and the vibration frequency of the vibrating plate is adjusted to 70 Hz. 50000 ml of the aqueous solution of the L-arabinose/calcium chloride/edible glycerol at a temperature of 50° C. is used, the spraying flow is 53 ml/min, wherein the aqueous solution of the L-arabinose contains the dry matter of the L-arabinose in mass percentage of 50%, the dry matter of the calcium chloride of 16% and the edible glycerol of 10%. For the vibration fluidized bed drying apparatus, the drying temperature is 40° C.; and the vacuum degree of vacuum drying is −0.1 MPa. In the obtained product, the L-arabinose has a mass content of 4.6%, and the edible sugar has a mass content of 93%, the calcium chloride has a mass content of 1.5%, and the edible glycerol has a mass content of 0.9%.

In order to make the L-arabinose, the edible sugar, the calcium chloride and the edible glycerol reach the respective target mass content(s), it is possible to adjust, in a limited range, the volume of the aqueous solution, and the mass percentages of the L-arabinose, the calcium chloride and the edible glycerol in the aqueous solution, wherein the L-arabinose has its target mass percentage of 1%˜20%, the edible sugar has its target mass percentage of 80%˜99%, the dry matter of the calcium chloride has its target mass percentage of 0.5%˜1.5%, the edible glycerol has its target mass percentage of 0.5%˜1.5%, and the water content in the sugar product containing L-arabinose is accounted within the target mass percentage of the edible sugar.

In a using method of the sugar product obtained in the above embodiments, in food processing or cooking or drink preparing, the sugar product is used to replace the originally needed edible sugar in equal amount.

The above embodiments can achieve at least the following beneficial effects:

1. In the embodiments of the present invention, as the sugar product is presented in a form of the edible sugar particle and the L-arabinose enclosing the surface of the edible sugar particle, the L-arabinose can distribute relatively uniformly among the edible sugar particles. The L-arabinose can suppress intake of sucrose in the edible sugar by the human body. The sugar product as provided in the present invention not only ensures uniform distribution of the L-arabinose on the surface of the edible sugar, but also is a healthy type sweetener which can be used in the fields of food processing, cooking and drink preparing, etc.

2. In the embodiments of the present invention, the sugar product as provided has its sweetness consistent with that of sucrose in equal amount. Therefore, when it is used in the fields of food processing, cooking, drink preparing, etc, it is only necessary to use it to replace sucrose in equal amount, without need of re-adjusting the recipe(s) for food processing, cooking and drink preparing, thus significantly simplifying the application development procedure of the sugar product.

3. In the embodiments of the present invention, the sugar product further comprises calcium chloride which can improve the gloss of the sugar product. In addition, the calcium chloride tetrahydrate can provide the human body with necessary calcium element such that the sugar product is also nutritious.

4. In the embodiments of the present invention, the sugar product further comprises edible glycerol which can effectively improve the taste of the sugar product such that the food added with the sugar product tastes smoothly.

Although the embodiments of the present invention have been shown and described above, it can be understood that the embodiments above are exemplary and cannot be construed as limiting the present invention. Those skilled in the art can change, modify, replace and deform the embodiments above in the scope of the present invention without departing from the principle and purpose of the present invention.

What is claimed is:

1. A sugar product containing L-arabinose, comprising an edible sugar particle and an L-arabinose enclosing a surface of the edible sugar particle, wherein
the edible sugar particle has a particle diameter of 0.15 mm˜0.25 mm;
the L-arabinose has an enclosing thickness of 0.001 mm˜0.08 mm; and
in each mass part of the sugar product containing L-arabinose, the edible sugar particle accounts for 80%˜99% in mass percentage, and a dry matter of the L-arabinose accounts for 1%˜20% in mass percentage.

2. The sugar product containing L-arabinose according to claim 1, wherein
the surface of the edible sugar particle further comprises calcium chloride; and
in each mass part of the sugar product containing L-arabinose, a dry matter of the calcium chloride accounts for 0.5%˜1.5% in mass percentage.

3. The sugar product containing L-arabinose according to claim 1, wherein
the surface of the edible sugar particle further comprises an edible glycerol; and
in each mass part of the sugar product containing L-arabinose, the edible glycerol accounts for 0.5%˜1.5% in mass percentage.

4. The sugar product containing L-arabinose according to claim 1, wherein
the edible sugar comprises any one or more of raw sugar, white granulated sugar, soft white sugar, brown granulated sugar, golden granulated sugar, brown sugar powder, and crystal sugar powder.

5. A preparing method for the sugar product containing L-arabinose according to claim 1, comprising:
placing edible sugar particles on a vibrating plate, wherein the edible sugar particles are placed with a thickness of 10 mm˜50 mm;
preheating the edible sugar particles to 30˜50° C.;
adjusting a vibration frequency of the vibrating plate to a target frequency, and the vibrating plate keeping vibrating at the target frequency;
spraying an aqueous solution of the L-arabinose in mass percentage of 45%˜55% onto the edible sugar particles to obtain a solid-liquid mixture wherein the aqueous solution of the L-arabinose has a temperature of 30˜50° C.;
after spraying, the vibrating plate continuing vibrating for 3˜5 minutes;
using a vibration fluidized bed drying apparatus to dry the solid-liquid mixture wherein the vibration fluidized bed drying apparatus is used at a drying temperature of 30˜60° C. and for a drying period of 15˜30 minutes; and
using a vacuum drying manner to further dry the dried solid-liquid mixture wherein the vacuum drying manner is used with a vacuum degree of −0.1˜0 MPa and for a drying period of 40˜60 minutes.

6. The preparing method according to claim 5, wherein
a relation between a mass of the edible sugar particles placed on the vibrating plate, the target frequency and a flow of spraying the aqueous solution of the L-arabinose meets the following first adjusting formula group:
$$\{ \begin{matrix}\frac{1}{5} \leq \frac{m}{M} \leq \frac{1}{3} , & R = 30 + ⌊ \frac{m}{100} ⌋ \times 10 , & f = ⌈ 20 + \frac{m}{M} \times 60 ⌉ \\ \frac{1}{3} \leq \frac{m}{M} \leq \frac{2}{3} , & R = 40 + ⌈ \frac{m}{100} ⌉ \times 10 , & f = ⌈ 15 + \frac{m}{M} \times 75 ⌉ \\ \frac{2}{3} \leq \frac{m}{M} \leq 1 , & R = 50 + ⌈ \frac{m}{100} ⌉ \times 10 , & f = ⌈ 25 + \frac{m}{M} \times 50 ⌉\end{matrix}$$
wherein m indicates the mass of the edible sugar particles placed on the vibrating plate, in a unit of kg; M indicates a maximum capability of the vibrating plate, in a unit of kg, and 300 kg≤M≤500 kg; R indicates the target frequency, in a unit of Hz; F indicates the flow of spraying the aqueous solution of the L-arabinose, in a unit of milliliter/minute.

7. The preparing method according to claim 5, wherein
when the surface of the edible sugar particle further comprises calcium chloride and in each mass part of the sugar product containing L-arabinose, a dry matter of the calcium chloride accounts for 0.5%˜1.5% in mass percentage,
the step of spraying an aqueous solution of the L-arabinose in mass percentage of 45%˜55% onto the edible sugar particles comprises:
spraying the aqueous solution of the L-arabinose/calcium chloride onto the edible sugar particles, wherein the aqueous solution of the L-arabinose/calcium chloride contains the dry matter of the L-arabinose in mass percentage of 45%˜55% and a dry matter of the calcium chloride in mass percentage of 10%˜20%.

8. The preparing method according to claim 7, wherein
a relation between a mass of the edible sugar particles placed on the vibrating plate, the target frequency and a flow of spraying the aqueous solution of the L-arabinose/calcium chloride meets the following second adjusting formula group:
$$\{ \begin{matrix}\frac{1}{5} \leq \frac{m}{M} \leq \frac{1}{3} , & R = 30 + ⌊ \frac{m}{100} ⌋ \times 10 , & f = ⌈ 20 + \frac{m}{M} \times 60 ⌉ \\ \frac{1}{3} \leq \frac{m}{M} \leq \frac{2}{3} , & R = 40 + ⌈ \frac{m}{100} ⌉ \times 10 , & f = ⌈ 15 + \frac{m}{M} \times 75 ⌉ \\ \frac{2}{3} \leq \frac{m}{M} \leq 1 , & R = 50 + ⌈ \frac{m}{100} ⌉ \times 10 , & f = ⌈ 25 + \frac{m}{M} \times 50 ⌉\end{matrix}$$
wherein m indicates the mass of the edible sugar particles placed on the vibrating plate, in a unit of kg; M indicates a maximum capability of the vibrating plate, in a unit of kg, and 300 kg≤M≤500 kg; K indicates the target frequency, in a unit of Hz; P indicates the flow of spraying the aqueous solution of the L-arabinose/calcium chloride, in a unit of milliliter/minute.

9. A using method for the sugar product containing L-arabinose according to claim 1, wherein in food processing or cooking or drink preparing, the sugar product containing L-arabinose is used to replace the originally needed sucrose in equal amount.
